(19) United States
(12) Patent Application Publication
(10) Pub. No.: US 2026/0210767 A1
(43) Pub. Date: Jul. 23, 2026

(54) INFRARED DETECTOR AND ASSOCIATED PRODUCTION METHOD

(71) Applicant: LYNRED, Palaiseau (FR)

(72) Inventors: Pascal Le Boterf, Veurey-Voroize (FR); Nicolas Boudou, Grenoble (FR); Sylvain Lemettre, Massy (FR)

(21) Appl. No.: 19/142,838

(22) PCT Filed: Dec. 13, 2023
(86) PCT No.: PCT/FR2023/051993

§ 371 Date: Jun. 24, 2025

(30) Foreign Application Priority Data
Feb. 6, 2023 (FR) 2301102

(51) Int. Cl. G01J 5/02; G01J 5/04; G01J 5/0802; G01J 5/0875; G01J 5/20

(52) U.S. Cl. CPC G01J 5/0235; G01J 5/0205; G01J 5/024; G01J 5/045; G01J 5/0802; G01J 5/0875; G01J 5/20; G01J 2005/202

(57) ABSTRACT

This infrared detector includes a base substrate supporting an array of micro-bolometers, each micro-bolometer mounted in suspension above the substrate by anchoring nails extending substantially perpendicularly with respect to the base substrate. Side walls extend substantially perpendicularly with respect to the base substrate, and an optical window is fixed to an upper end of the side walls above the micro-bolometers. The base substrate, the side walls, and the optical window form a vacuum sealed cavity within which the micro-bolometers are present. The infrared detector also comprises spacers extending plumb with at least 10% of the anchoring nails, these spacers being also oriented substantially perpendicularly with respect to the base substrate, said spacers forming a stop capable of cooperating with the lower face of the optical window, or with the upper end of the anchoring nails, and thus limiting the deflections of the optical window and/or of the substrate.

### FIELD OF THE INVENTION

The invention relates to the field of infrared detection, and particularly detection implementing micro-bolometers.

More particularly, the invention concerns an infrared detector formed by using the transfer fabrication of an optical window on a base substrate. In this context, the invention aims at limiting deflections likely to appear, during the vacuum sealing after this transfer, between the optical window and the base substrate. This limitation of deflections particularly enables to obtain infrared detectors, formed by using transfer fabrication, with a large number of pixels and/or with an increased accuracy.

Thus, the invention may be implemented in many fields for which infrared images are currently used, such as the fields of aerospace, security, defense, transport, thermography, industrial inspection, building inspection, leisure activities, health.

### BACKGROUND

As schematically illustrated in FIG. 1, an infrared detector 100 conventionally appears in the form of a sealed cavity 16 incorporating an array of micro-bolometers 19. Each micro-bolometer 19 comprises a membrane 15 mounted in suspension on a base substrate 11 by means of anchoring nails 14. The sealed cavity 16 is generally formed by an optical window 12 and side walls 13 fixed between base substrate 11 and optical window 12.

A micro-bolometer 19 is for example designed to have a maximum sensitivity over the 8-14-micrometer wavelength range of interest, while being little sensitive to the flux outside this spectral band. Intrinsically, the non-treated optical window has a transmittance wider than the wavelength range of interest.

To improve the performance of infrared detector 100, this optical window is treated or structured opposite micro-bolometers 19. Typically, this optical window is intended to attenuate wavelengths in the range from 2 to 8 micrometers, and to form an anti-reflection filter for wavelengths of interest in the range from 8 to 14 micrometers.

For this purpose, optical window 12 may comprise a first filter 17 and a second filter 18, respectively formed on the lower surface and the upper surface of optical window 12.

Further, for certain applications, it is desired to obtain a plurality of distinct responsivity measurements for a same point of an infrared image, for example with a plurality of micro-bolometers 19 sensitive in different spectral bands. For example, based on a plurality of distinct responsivity measurements, it is possible to determine the absolute temperature, that is, a measurement of the temperature of an object of interest without using a reference object.

For this purpose, distinct filters may be associated with distinct micro-bolometers 19. This embodiment however requires limiting the distance between optical window 12 and micro-bolometers 19 so that infrared radiation intended for a specific micro-bolometer 19 mainly crosses the associated filter.

It may also be desired to limit the distance between optical window 12 and micro-bolometers 19 to simplify the production method.

Further, the performance of infrared detector 100 is also linked to the vacuum level inside sealed cavity 16. To guarantee the thermal insulation of micro-bolometers 19, necessary to achieve the expected performance, the vacuum level in sealed cavity 16 typically needs to be lower than 10-2 mbar. To guarantee this vacuum level, in the transfer fabrication technique, optical window 12 is vacuum-sealed at an upper end of side walls 13 above base substrate 11 and micro-bolometers 19.

In addition to transfer fabrication, it is also known to carry out a monolithic fabrication, such as described in document US 2002/0175284, in which sacrificial layers are implemented to deposit the optical window on the base substrate. In this method, alternative to transfer fabrication, a vent is necessarily used to remove the sacrificial layers.

Document US 2018/0321087 describes still another type of hybrid fabrication between monolithic fabrication and transfer fabrication. Indeed, in this document, the base substrate is conventionally formed with sacrificial layers and, as in transfer fabrication, the optical window is formed separately from the base substrate.

However, the optical window incorporates a vent and it is transferred onto the base substrate while the sacrificial layers are still present. The sealing of the optical window to the base substrate is performed with these sacrificial layers, and the latter are then necessarily removed via the vent before vacuuming the cavity and depositing a vent sealing layer.

The invention more specifically aims at transfer fabrication, detectable on an infrared detector 100 since the optical window comprises no vent.

In this production method, after the vacuum sealing of optical window 12 at an upper end of side walls 13, the level of vacuum may cause a deflection of optical window 12 and/or of base substrate 11, as illustrated in FIG. 1. These deflections decrease the distance Hmin between optical window 12 and base substrate 11. Thus, for applications where the distance between optical window 12 and micro-bolometers 19 is small, in the order of from 10 to 20 micrometers, if the deflections are too significant, typically greater than 10 micrometers, optical window 12 may come into contact with micro-bolometers 19, or even destroy or damage them. Further, the deflection of optical window 12 may also cause a degradation in the filtering properties of filters 17-18 and disturb the optical signal received by micro-bolometers 19.

The deflection mainly depends on the vacuum level in sealed cavity 16, on the outside pressure, that is, the pressure of the medium in which the detector is located, on the surface area of infrared detector 100, on the thickness Es and on the nature of base substrate 11, and on the thickness Ef and on the nature of optical window 12.

In practice, for an application in which the inner vacuum level and the pressure outside cavity 16 are known, it is possible to determine the limits of the surface area possible for infrared detector 100 according to the thickness Es and to the nature of base substrate 11 and to the thickness Ef and to the nature of optical window 12.

For example, for a 10-2-mbar inner vacuum and an outside pressure of one bar and a thickness Es of base substrate 11 of 725 micrometers, it has been determined that it is possible to obtain an infrared detector 100 of 1,600 by 1,200 pixels with a pixel pitch of 12 micrometers and a distance at the time of the sealing between optical window 12 and micro-bolometers 19 of 10 micrometers, but not an infrared detector 100 of 2,048 by 1,536 pixels with a thickness Ef of optical window 12 of 725 micrometers. Indeed, for an infrared detector 100 of 2,048 by 1,536 pixels, it has been numerically determined that the deflection of optical window 12 is greater than 10 micrometers.

Under these conditions, the filtering properties of filters 17-18 are so degraded that the effect of this degradation is visible on the obtained infrared image.

In another example with a pixel pitch of 12 micrometers and a distance at the time of the sealing between optical window 12 and micro-bolometers 19 of 10 micrometers, for a 10-2-mbar inner vacuum and an outside pressure of one bar and a thickness Es of base substrate 11 of 725 micrometers, it has been determined that it is possible to obtain an infrared detector 100 of 1,024 by 768 pixels, but not an infrared detector 100 of 1,280 by 1,024 pixels with a thickness Ef of optical window 12 of 300 micrometers. In this example, an infrared detector 100 of 1,280 by 1,024 pixels would cause a deflection of optical window 12 greater than 10 micrometers and a visible degradation of the filtering properties of filters 17-18.

Thus, the deflection phenomenon limits possibilities of forming of an infrared detector 100 for applications in which the distance between optical window 12 and micro-bolometers 19 is short. The technical problem that the invention aims at solving thus consists in providing an infrared detector having a large-size and/or thin substrate and optical window while limiting deflection.

### SUMMARY OF THE DISCLOSURE

The invention aims at addressing this technical problem by placing spacers between the upper end of at least part of the anchoring nails and the lower surface of the optical window.

These spacers form a mechanical stop capable of opposing these deflections of the optical window and/or of the base substrate.

Thus, the invention concerns an infrared detector comprising:

a base substrate supporting an array of micro-bolometers, each micro-bolometer being mounted in suspension above said substrate by means of anchoring nails extending substantially perpendicularly with respect to the base substrate;

side walls extending substantially perpendicularly with respect to the base substrate; and

an optical window fixed to an upper end of the side walls above the micro-bolometers, the optical window comprising no vent;

the base substrate, the side walls, and the optical window forming a vacuum sealed cavity within which the micro-bolometers are present.

According to the invention, the infrared detector also comprises spacers extending vertically in line with at least 10% of the anchoring nails, these spacers being also oriented substantially perpendicularly with respect to the base substrate, said spacers forming a stop capable of cooperating with the lower surface of the optical window, or with the upper end of the anchoring nails, and thus limiting deflections of the optical window and/or of the substrate.

The invention thus enables, with transfer fabrication, to limit deflections of the optical window and/or of the substrate. With these limited deflections, it is now possible to limit the thickness of the optical window and of the base substrate without risking damaging the micro-bolometers after vacuum sealing of the sealed cavity. Indeed, the optical window no longer risks coming into contact with the suspended membranes of the micro-bolometers.

For bulk needs, it is also possible to limit the volume of the sealed cavity by decreasing the distance between the optical window and the base substrate.

Taking the example of the state of the art, with a 12-micrometer pixel pitch, a distance during the sealing between the optical window and the micro-bolometers of 10 micrometers, a 10⁻2-mbar inner vacuum, and an outside pressure of one bar, a thickness of the base substrate and of the optical window of 725 micrometers, it is now possible with the invention to obtain an infrared detector of 2,048 by 1,536 pixels.

To obtain this deflection limiting effect, at least 10% of the anchoring nails need to be associated with a spacer oriented substantially perpendicularly with respect to the base substrate.

These spacers may be uniformly distributed over the anchoring nails, for example over all the anchoring nails or every 2, 4, or 8 anchoring nails in a row.

As a variant, the spacers may also be distributed according to a non-uniform distribution law which increases the number of spacers at the center of the infrared detector.

This embodiment enables to limit the number of spacers by placing a large number of spacers in the areas most sensitive to deflections, typically the center of the infrared detector.

To ensure the mechanical support of the optical window, the spacers may have a transverse cross-section area in the range from 0.5 to 1.5 square micrometer.

Further, the height of the spacers may be at least twice greater than that of the anchoring nails, typically a 5-micrometer height as compared with a height of the anchoring nails in the order of 2 micrometers.

In practice, the contact between the spacers and the optical window or the anchoring nails is observed after vacuum sealing of the cavity. Thus, before the vacuum sealing of the cavity, the spacers may be previously fixed to the optical window or to the anchoring nails. To obtain the vacuum sealing of the cavity, the base substrate and the optical window are placed in a vacuum sealing furnace. After the sealing, the pressure rises in the sealing furnace and deflections of the optical window or of the base substrate may then appear.

Thus, in an embodiment, the spacers are formed on the lower surface of the optical window and come into contact with the anchoring nails of the base substrate after vacuum sealing of the cavity formed around the micro-bolometers by the base substrate, the side walls, and the optical window.

According to another embodiment, the spacers are formed in line with the anchoring nails of the base substrate and come into contact with the optical window after vacuum sealing of the cavity formed around the micro-bolometers by the base substrate, the side walls, and the optical window.

In this embodiment, it may be necessary to provide areas for receiving the spacers on the optical window. Thus, the optical window may be provided with planar areas intended to cooperate with the upper end of the spacers after vacuum sealing of the cavity.

Indeed, the optical window may be provided on its upper surface with a multilayer interference filter or with a periodic diffraction grating, and on its lower surface, with a multilayer interference filter or with a periodic diffraction grating. When the lower surface is structured by a periodic diffraction grating, it is advantageous to provide planar areas for receiving the spacers and limiting possible damage to the patterns of said grating.

As a variant, to protect the patterns of the periodic diffraction grating without limiting the useful surface area thereof on the lower surface of the optical window, an upper support, transparent to radiation in the wavelength range of interest of the micro-bolometers, may be formed on the spacers.

In this embodiment, the infrared detector comprises an upper support fixed to the upper end of the spacers and placed between the spacers and the optical window after vacuum sealing of the cavity. The wavelength range of interest typically corresponds to the 8-14 micrometer range.

To form the spacers on the anchoring nails, the invention may implement known steps of additive manufacturing by using a plurality of sacrificial layers.

Thus, the invention also concerns a method of manufacturing an infrared detector comprising the following steps:

deposition and structuring of a first sacrificial layer on a base substrate;

forming of anchoring nails through the first sacrificial layer to reach the base substrate;

forming of membranes on the first sacrificial layer and the anchoring nails;

deposition and structuring of a second sacrificial layer on the membranes and the first sacrificial layer;

forming of spacers through the second sacrificial layer and in line with part at least of the anchoring nails; and

removal of the sacrificial layers so as to release the micro-bolometers formed by the membranes and the anchoring nails;

forming of an optical window;

forming of side walls on the base substrate or the optical window and around the micro-bolometers; the side walls being formed before the removal of the sacrificial layers when they are formed on the base substrate;

transfer of the optical window onto the base substrate; and

vacuum sealing of the cavity formed by the base substrate, the side walls, and the optical window; the spacers forming a stop capable of cooperating with the lower surface of the optical window and thus limiting deflections of the optical window and/or of the substrate; when the spacers are formed on the lower surface of the optical window, they come into contact with the anchoring nails of the base substrate after vacuum sealing of the cavity and, when the spacers are formed in line with the anchoring nails of the base substrate, they come into contact with the optical window after vacuum sealing of the cavity.

This method enables to reuse known additive manufacturing steps to form the spacers on the anchoring nails. It is thus possible to obtain an infrared detector with spacers limiting deflections while using convention infrared detector production tools.

### BRIEF DESCRIPTION OF THE DRAWINGS

The invention will be better understood on reading of the following description, given as an example only, in relation with the accompanying drawings, in which the like references designate the like or similar elements, and in which:

FIG. 1 illustrates a simplified cross-section view of an infrared detector of the state of the art;

FIG. 2 illustrates a simplified cross-section view of an infrared detector according to a first embodiment of the invention before the step of vacuum sealing of the package;

FIG. 3 illustrates a simplified cross-section view of the infrared detector of FIG. 2 after the step of vacuum sealing of the package;

FIG. 4 illustrates a simplified cross-section view of an infrared detector according to a second embodiment of the invention before the step of vacuum sealing of the package;

FIG. 5 illustrates a simplified cross-section view of the infrared detector of FIG. 4 after the step of vacuum sealing of the package;

FIG. 6 illustrates a simplified cross-section view of an infrared detector according to a third embodiment of the invention before the step of vacuum sealing of the package;

FIG. 7 illustrates a simplified cross-section view of the infrared detector of FIG. 6 after the step of vacuum sealing of the package;

FIG. 8 illustrates a simplified cross-section view of an infrared detector according to a fourth embodiment of the invention before the step of vacuum sealing of the package;

FIG. 9 illustrates a simplified cross-section view of the infrared detector of FIG. 8 after the step of vacuum sealing of the package; and

FIGS. 10 to 16 illustrate a simplified cross-section view of the steps of forming of a base substrate of the infrared detector of FIG. 2.

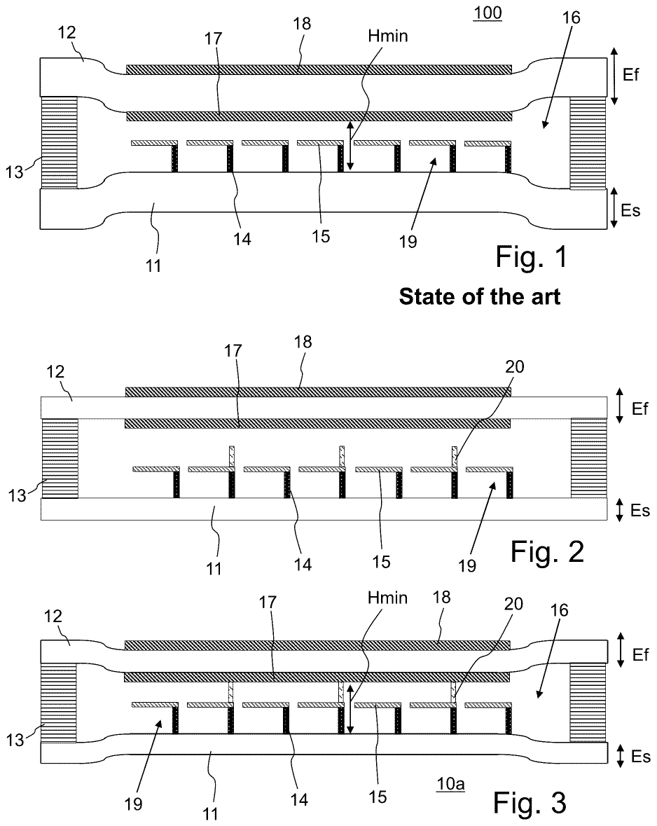

### DETAILED DESCRIPTION

To limit deflection between the optical window 12 and the base substrate 11 of an infrared detector with transfer fabrication, the invention provides using spacers 20. FIGS. 3, 5, 7, and 9 illustrate four different embodiments enabling to limit this deflection.

In all these embodiments, base substrate 11 supports an array of micro-bolometers 19. More specifically, each micro-bolometer 19 comprises a membrane 15 mounted in suspension above base substrate 11 by means of anchoring nails 14. For example, each membrane 15 may be mounted on two or four anchoring nails 14 by means of suspension arms aiming at limiting thermal conduction between membrane 15 and base substrate 11. Further, base substrate 11 may also support a reflector arranged under membranes 15.

Micro-bolometers 19 are conventionally arranged in the form of an array of rows and of columns to form the image points, or pixels, of an infrared image.

In addition to the micro-bolometers 19 shown in FIGS. 2 to 9, other types of micro-bolometers 19 may also be structured on base substrate 11, for example micro-bolometers thermalized with the substrate, so as to reject a non-useful component of the signal, referred to as common-mode component, which may be widely predominating. The rejection of this component enables to read the useful signal by using to the greatest possible extent the electrical dynamic range of the readout circuit.

In the embodiment of FIGS. 2 to 7, spacers 20 are formed on a plurality of anchoring nails 14 of the detection micro-bolometers 19.

More specifically, according to the invention, spacers 20 extend vertically in line with at least 10% of the anchoring nails 14 and substantially perpendicularly with respect to base substrate 11. In the example of FIGS. 2 to 7, one micro-bolometer 19 out of two comprises spacers 20 fixed to anchoring nails 14. As a variant, the distribution of spacers 20 may take different forms without changing the invention, as long as at least 10% of the anchoring nails 14 are topped with spacers 20. Thus, the distribution of spacers 20 may be uniform. These spacers 20 may in particular be placed on all the anchoring nails 14, on one anchoring nail 14 out of two, on one anchoring nail 14 out of four, or also on one anchoring nail 14 out of eight, without changing the invention.

Further, the distribution of the anchoring nails 14 may also be non-uniform, that is, more spacers 20 are placed in certain areas of infrared detector 10a-10d. Typically, it may be desired to have one spacer 20 positioned on each anchoring nail 14 on a substantially central area of infrared detector 10a-10d, while a peripheral area has one spacer 20 out of two or out of four anchoring nails 14. The limit between the central area and the peripheral area of infrared detector 10a-10d may be determined so that the central area covers a surface area twice smaller than the peripheral area, or by any other mathematical definition.

In addition to base substrate 11 and its micro-bolometers 19, an infrared detector 10a-10d also comprises an optical window 12 fixed to an upper end of side walls 13 and above micro-bolometers 19. The side walls 13 may be formed independently of base substrate 11 and of optical window 12 and fixed to base substrate 11 before the transfer of optical window 12. As a variant, it is possible to structure base substrate 11 or optical window 12 so as to form side walls 13.

For example, these side walls 13 may be made of amorphous silicon enabling to laterally encapsulate micro-bolometers 19. Whatever the technology for the forming of side walls 13, the latter extend substantially perpendicularly with respect to base substrate 11 and enable to form a vacuum sealed cavity 16 by fixing optical window 12 to the upper ends of said walls.

To limit deflections, spacers 20 form a stop between the anchoring nails 14 of micro-bolometers 19 and optical window 12. Conventionally, optical window 12 is structured by filters enabling to limit incident radiation on micro-bolometers 19.

In the example of FIGS. 2 and 3, optical window 12 is structured with two multilayer interference filters 17 and 18. The total thickness Ef of optical window 12 thus corresponds to the thickness of the substrate of this optical window 12 added to the thickness of the two multilayer interference filters 17 and 18. As illustrated in FIG. 2, when optical window 12 is transferred onto base substrate 11, spacers 20 do not necessarily touch optical window 12. after vacuum sealing, necessary to form the infrared detector 10a illustrated in FIG. 3, a deflection appears and this deflection causes a contact between spacers 20 and optical window 12. More specifically, in the example of FIG. 3, spacers 20 come into contact with the multilayer interference filter 17 formed on the lower surface of optical window 12.

The height of anchoring nails 14 and of spacers 20 enables to define the minimum height Hmin of cavity 16. Indeed, when optical window 12 comes into contact with spacers 20, the deflections of optical window 12 and/or of base substrate 11 are limited. Typically, the height of anchoring nails 14 may be in the range from 2 to 2.5 micrometers while the height of spacers 20 may be in the range from 5 to 10 micrometers.

Spacers 20 preferably have a smaller cross-section area than anchoring nails 14. Typically, anchoring nails 14 may have a cross-section area of 2 square micrometers while spacers 20 may have a transverse cross-section area in the range from 0.5 to 1.5 square micrometer. Given the height and the cross-section area of spacers 20, and if they are made of the same material, the latter are thus much less thermally conductive than anchoring nails 14. Further, the anchoring nails 14 conventionally incorporate metal elements enabling to form an area for contact with membrane 15. Now, these metal elements are natural heat conductors. As concerns spacers 20, they have no electric conduction function so that they can be made of a thermally-insulating material, such as amorphous silicon.

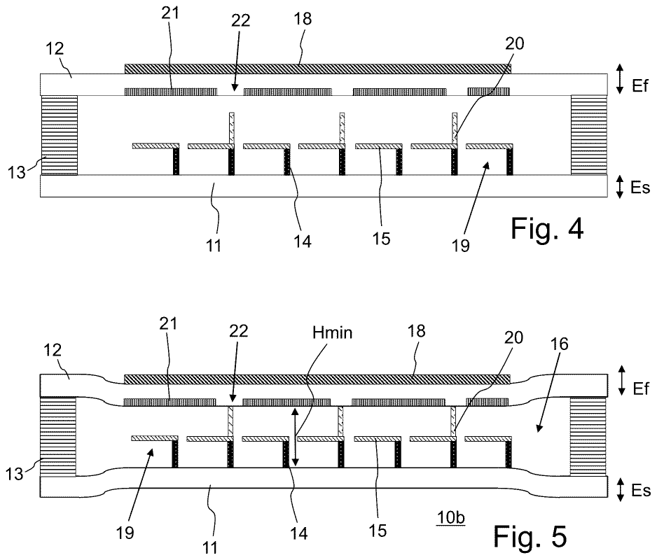

In the example of FIGS. 4 and 5, optical window 12 has a periodic diffraction grating 21 structured on its lower surface. This periodic diffraction grating enables, like the interference multilayer filters, to filter part of the incident infrared radiation. However, such a periodic diffraction grating is more sensitive to risks of damage due to the contact with a spacer 20. To limit this risk, it is possible to provide planar areas 22, that is, areas in which no structure of a periodic diffraction grating 21 is formed. These planar areas 22 are intended to cooperate with the upper end of spacers 20 after vacuum sealing of cavity 16.

Typically, with spacers 20 having a cross-section area of approximately 1 square micrometer, and an accuracy of alignment of optical window 12 with respect to base substrate 11 in the order of 2 micrometers at the time of the transfer of optical window 12, planar areas having a side length in the range from 3 to 5 micrometers may be formed.

Thus, for the infrared detector 10b of FIG. 5, spacers 20 come into contact with the planar areas 22 of optical window 12 after vacuum sealing of cavity 16, so as to limit possible damage to periodic diffraction gratings 21.

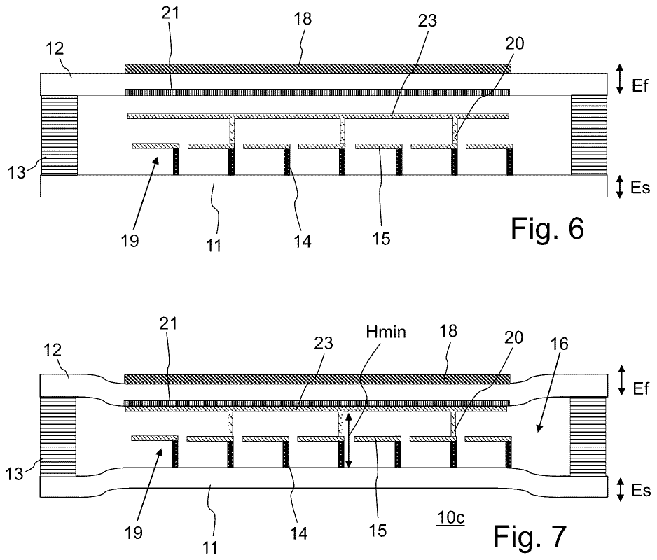

In the example of FIGS. 6 and 7, an upper support 23, transparent to infrared radiation in the wavelength range of interest of micro-bolometers 19, is placed above spacers 20. This upper support 23 enables to form a bearing area for optical window 12 to distribute the mechanical support pressure of spacers 20 with optical window 12. Thereby, the risk of damage to a periodic diffraction grating 21 formed on the lower surface of optical window 12 is limited, and it is no longer necessary to form planar areas. Further, this upper support extends over the entire surface of micro-bolometers 19 in the example of FIGS. 6 and 7. As a variant, this upper support 23 may extend only at the center of infrared detector 10c.

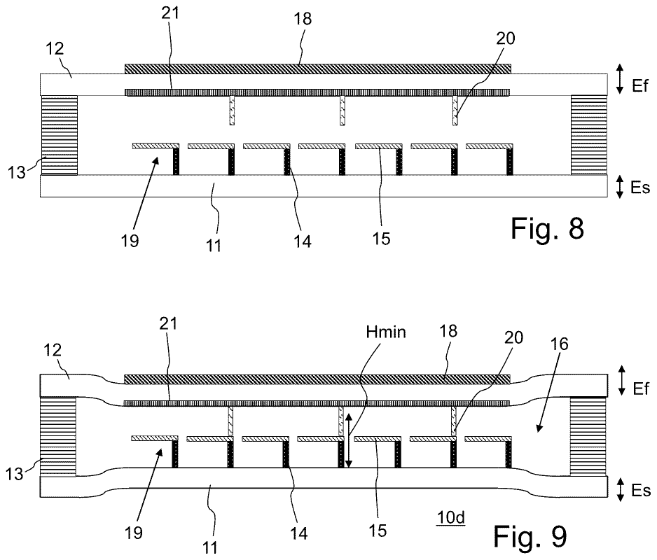

In the example of FIGS. 8 and 9, spacers 20 are fixed to the lower surface of optical window 12 and come into contact with the anchoring nails 14 after vacuum sealing of cavity 16. This embodiment also enables to guarantee a minimum height Hmin between optical window 12 and base substrate 11.

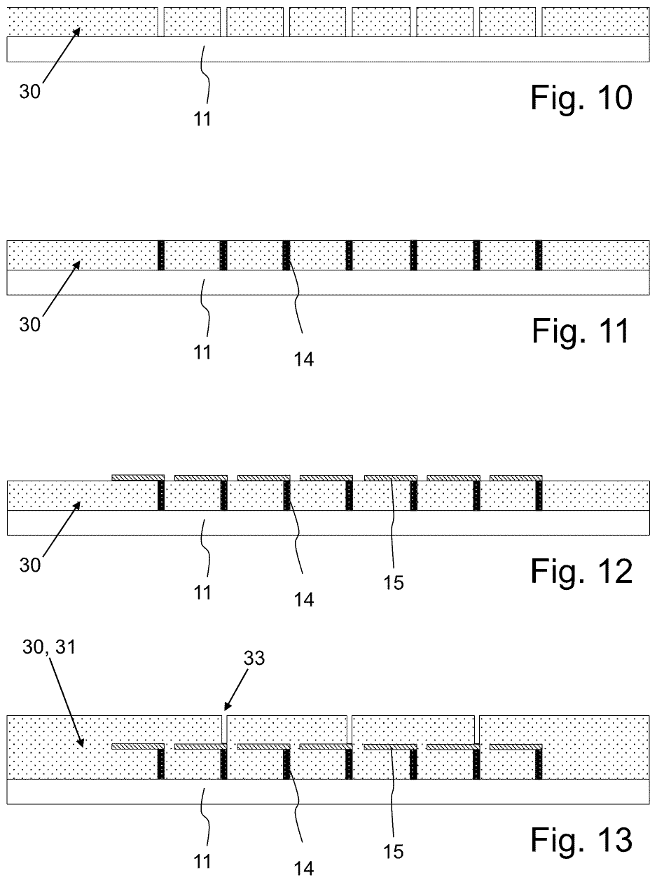

FIGS. 10 to 16 illustrate an embodiment of spacers 20 on the anchoring nails 14 of a base substrate 11.

For this purpose, a first step comprises depositing and structuring a sacrificial layer 30 on a base substrate 11. The anchoring nails 14 are then formed during a second step within the structuring patterns of sacrificial layer, as illustrated in FIG. 11. The membranes 15 of the different micro-bolometers 19 are then formed on sacrificial layer 30 and the anchoring nails 14, as illustrated in FIG. 12.

A second sacrificial layer 31 is deposited on membranes 15 and on the first sacrificial layer 30. This second sacrificial layer 31 is also structured to define areas where spacers 20 are to be formed, and in the case in point, in line with the anchoring nails 14, as illustrated in FIG. 13.

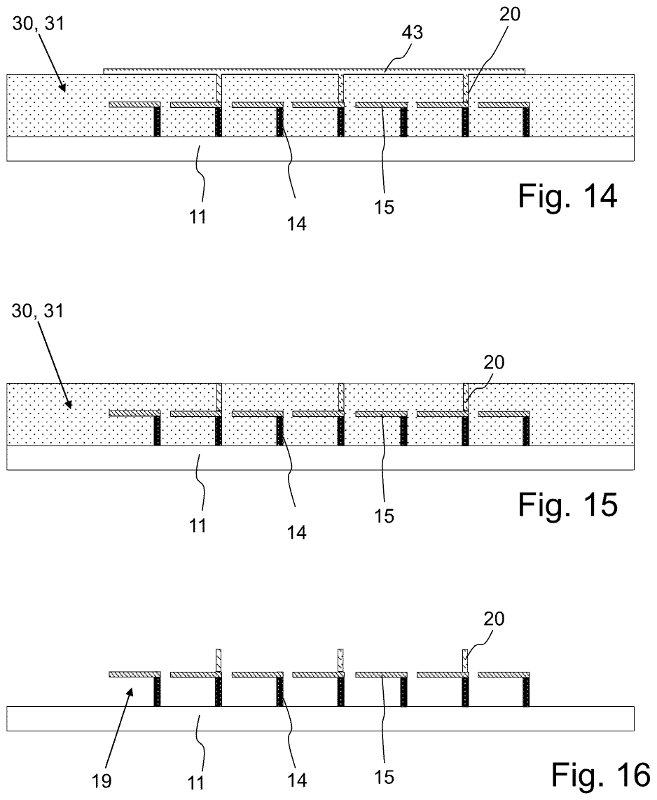

As illustrated in FIG. 14, spacers 20 may then be formed by deposition of material into the structuring patterns of the second sacrificial layer 31. This deposit may be made of amorphous silicon formed by physical vapor deposition.

The thin film of amorphous silicon 43 deposited on the second sacrificial layer 31 may then be removed, for example by reactive ion etching, as illustrated in FIG. 15. As a variant, it is possible preserve this amorphous silicon layer 43 to obtain the upper support 23 of FIGS. 6 and 7. If this amorphous silicon layer 43 is preserved, it is necessary to form vents in this amorphous silicon layer 43 to enable to remove the two sacrificial layers 30 and 31.

Thus, after the removal of the two sacrificial layers 30 and 31 enabling to obtain the release of micro-bolometers 19, spacers 20 are fixed in line with at least part of the anchoring nails 14, as illustrated in FIG. 16.

To obtain an infrared detector, one also needs to form optical window 12, to form side walls 13 on base substrate 11 or on optical window 12, to transfer optical window 12 onto base substrate 11, and to vacuum seal optical window 12 on base substrate 11 so as to form cavity 16.

When the side walls 13 are formed on base substrate 11, they are conventionally formed before the release of micro-bolometers 19.

Thereby, the invention enables to obtain a cavity 16 with a fixed minimum height Hmin between base substrate 11 and optical window 12 so that it is possible to use a base substrate 11 with a thickness Es smaller than thicknesses of the state of the art or also an optical window 12 with a thickness Es smaller than thicknesses of the state of the art by overcoming the constraints of closeness of these two elements. It is also possible to form infrared detectors 10a-10d with detection surfaces areas greater than the surface areas of the state of the art.

More specifically, with a 10⁻2-mbar inner vacuum and an outside pressure of one bar, a thickness Es of base substrate 11 of 725 micrometers, and a thickness Ef of optical window 12 of 725 micrometers, it is now possible to obtain deflections smaller than 10 micrometers while forming an infrared detector 10a-10d with a resolution greater than or equal to 2,048 by 1,536 pixels.

Thus, by limiting the deflection phenomenon, the invention enables to obtain an infrared detector having a large-size and/or thin substrate and optical window. The invention for example enables to form an infrared detector with distinct filters for different micro-bolometers or, more simply, to limit the distance between optical window 12 and micro-bolometers 19 to simplify the manufacturing process or limit the bulk.

1. An infrared detector comprising:
a base substrate supporting an array of micro-bolometers, each micro-bolometer being mounted in suspension above said substrate by means of anchoring nails extending substantially perpendicularly with respect to the base substrate;
side walls extending substantially perpendicularly with respect to the base substrate; and
an optical window fixed to an upper end of the side walls above the micro-bolometers, the optical window comprising no vent;
the base substrate, the side walls, and the optical window forming a vacuum sealed cavity within which the micro-bolometers are present;
characterized in that the infrared detector also comprises spacers extending vertically in line with at least 10% of the anchoring nails, these spacers being also oriented substantially perpendicularly with respect to the base substrate, said spacers forming a stop capable of cooperating with the lower surface of the optical window, or with the upper end of the anchoring nails, and thus limiting deflections of the optical window and/or of the substrate.

2. The infrared detector according to claim 1, wherein the spacers have a transverse cross-section area in the range from 0.5 to 1.5 square micrometer.

3. The infrared detector according to claim 1, wherein the spacers are uniformly distributed over the anchoring nails.

4. The infrared detector according to claim 1, wherein the spacers are distributed according to a non-uniform distribution law which increases the number of spacers at the center of the infrared detector.

5. The infrared detector according to claim 1, wherein the spacers are formed on the lower surface of the optical window and come into contact with the anchoring nails of the base substrate.

6. The infrared detector according to claim 1, wherein the spacers are formed in line with the anchoring nails of the base substrate and come into contact with the optical window.

7. The infrared detector according to claim 6, wherein the optical window is provided with planar areas cooperating with the upper end of the spacers.

8. The infrared detector according to claim 6, wherein the infrared detector comprises an upper support, transparent to radiation in the wavelength range of interest of the micro-bolometers, fixed to the upper end of the spacers and placed between the spacers and the optical window.

9. The infrared detector according to claim 1, wherein the optical window comprises an upper surface provided with a multilayer interference filter or with a periodic diffraction grating, and a lower surface provided with a multilayer interference filter or with a periodic diffraction grating.

10. A method of manufacturing an infrared detector according to claim 5, comprising the following steps:
deposition and structuring of a first sacrificial layer on a base substrate;
forming of anchoring nails through the first sacrificial layer to reach the base substrate;
forming of membranes on the first sacrificial layer and the anchoring nails;
deposition and structuring of a second sacrificial layer on the membranes and the first sacrificial layer;
forming of spacers through the second sacrificial layer and in line with part at least of the anchoring nails; and
removal of the sacrificial layers (30, 31) so as to release the micro-bolometers formed by the membranes and the anchoring nails;
forming of an optical window;
forming of side walls on the base substrate or on the optical window and around the micro-bolometers; the side walls being formed before the removal of the sacrificial layers (30, 31) when they are formed on the base substrate;
transfer of the optical window onto the base substrate; and
vacuum sealing of the cavity formed by the base substrate, the side walls and the optical window; the spacers forming a stop capable of cooperating with the lower surface of the optical window and thus limiting deflections of the optical window and/or of the substrate;
the spacers coming into contact with the anchoring nails of the base substrate, or with the lower surface of the optical window after vacuum sealing of the cavity.
